(19) United States
(12) Patent Application Publication
(10) Pub. No.: US 2025/0265196 A1
(43) Pub. Date: Aug. 21, 2025

(54) SYSTEM AND METHODS FOR SOFTWARE PROGRAMMABLE CACHE MEMORY

(71) Applicant: Microchip Technology Incorporated, Chandler, AZ (US)

(72) Inventor: Hugo Alfonso Zuniga Calvo, Trondelag (NO)

(73) Assignee: Microchip Technology Incorporated, Chandler, AZ (US)

(21) Appl. No.: 18/927,229

(22) Filed: Oct. 25, 2024

Related U.S. Application Data
(60) Provisional application No. 63/554,081, filed on Feb. 15, 2024.

(51) Int. Cl. G06F 12/0895; G06F 9/30; G06F 12/0891

(52) U.S. Cl. CPC G06F 12/0895; G06F 9/30145; G06F 12/0891

(57) ABSTRACT

A software programmable cache memory may enable fast execution of frequently used blocks of code. The software programmable cache memory may match incoming instruction addresses with addresses stored in a content-addressable memory (CAM) and may read matching addresses from a volatile cache memory. Instruction addresses which do not match with addresses stored in the CAM may be fetched from a non-volatile memory coupled to the software programmable cache memory.

### PRIORITY

This application claims priority to commonly owned U.S. Provisional Patent Application No. 63/554,081 filed Feb. 15, 2024, the entire contents of which are hereby incorporated by reference for all purposes.

### FIELD OF THE INVENTION

The present disclosure relates to a system and method for a software programmable cache memory.

### BACKGROUND

Electronic devices (e.g., microcontrollers) may be used to control various electronic systems, including but not limited to touch screens. A microcontroller that is used to control a touch screen is commonly referred to as a touch controller. As part of the efforts towards the production of a faster touch controllers, designers have faced limitations related to the access time of non-volatile memory that stores the instructions to be executed by the central processing unit (CPU) on the touch controller. Given increasing clock frequency requirements for the touch controller, the CPU performance may be affected as the non-volatile memory may not be able to provide the instructions at the required speed.

Using an instruction cache solution may enable a designer to increase the performance of the system by storing highly used instructions in the instruction cache. Caching techniques including direct mapping and n-associative caches are possible implementations of the instruction cache. However, these technologies are better applied in cases when the product will be used in a general-purpose environment, where it is hard to predict the type of software that will be running on the device. This generality in the usage of the device justifies the extra area and power of a hardware implementation of the classic cache implementations (e.g., direct mapping and n-associative caches). In other words, these classic cache implementations require a lot of memory overhead which often require large amounts of physical space in the product.

In cases where the hardware is intended to support software that will be written by software experts with high knowledge of the electronic device, and where the hardware is often executing a known sequence of instructions, it may be possible to use a simpler cache mechanism in which the software takes the responsibility for indicating which sections of the non-volatile memory to store in the cache. As one of various examples, a touch controller may execute a known sequence of instructions for transmitting signals to electrodes, receiving signals at electrodes, computing coupling capacitance, and other common touch controller operations. This known sequence of instructions may be a dedicated code block.

Accordingly, there is a need for systems and methods to support a simpler cache mechanism in which the software takes the responsibility for indicating which sections of the non-volatile memory to store in the cache.

### SUMMARY

The examples herein enable a system and method for data communication in media with high permittivity and high electrical conductivity.

According to one aspect, an apparatus includes a non-volatile memory comprising a plurality of non-volatile memory code blocks, respective non-volatile memory code blocks containing a plurality of instructions to be executed by a processor. The apparatus may include a volatile cache memory comprising a plurality of cache code blocks, respective cache code blocks to receive one of the plurality of non-volatile memory code blocks. The volatile cache memory may provide an instruction based at least on a cache address. The apparatus may include an instruction decoder to receive an instruction address, the instruction address comprising a first portion and a second portion. The apparatus may include a content addressable memory (CAM). The CAM may include a storage array comprising a plurality of data words, respective data words comprising a valid tag and an index, respective data words corresponding to respective cache code blocks of the plurality of cache code blocks. The CAM may also include a comparison circuit, the comparison circuit to compare the first portion of the received instruction address and the respective indices of the plurality of data words in the storage array, and the comparison circuit to generate a volatile cache code block address based on the valid tag and a result of the comparison. The CAM may include a concatenation circuit to concatenate the volatile cache code block address and the second portion of the received instruction address to generate the cache address. The apparatus may include a block invalidation circuit coupled to the volatile cache memory, the block invalidation circuit to, based on receiving a write transaction to a valid cache code block of the plurality of cache code blocks, update at least one valid tag in the storage array of the CAM, the at least one valid tag corresponding to the valid cache code block of the plurality of cache code blocks, and to update at least one cache code block in the volatile cache memory.

According to one aspect, a system includes a processor. The system may include a non-volatile memory comprising a plurality of non-volatile memory code blocks, respective non-volatile memory code blocks containing a plurality of instructions to be executed by the processor. The system may include a software programmable cache memory apparatus coupled to the processor. The software programmable cache memory apparatus may include a volatile cache memory comprising a plurality of cache code blocks, respective cache code blocks to receive one of the plurality of non-volatile memory code blocks, the volatile cache memory to provide an instruction based at least on a cache address. The software programmable cache memory apparatus may include a content addressable memory (CAM). The CAM may include an instruction decoder to receive an instruction address, the instruction address comprising a first portion and a second portion. The CAM may include a storage array comprising a plurality of data words, respective data words comprising a valid tag and an index, respective data words corresponding to respective cache code blocks of the plurality of cache code blocks. The CAM may include a comparison circuit, the comparison circuit to compare the first portion of the received instruction address and the respective indices of the plurality of data words, and the comparison circuit to generate a volatile cache code block address based on the valid tag and a result of the comparison. The CAM may include a concatenation circuit to concatenate the volatile cache code block address of the comparison circuit and the second portion of the received instruction address to generate the cache address. The system may include a block invalidation circuit coupled to the volatile cache memory, the block invalidation circuit to, based on receiving a write transaction to a valid cache code block of the plurality of cache code blocks, update at least one valid tag in the storage array of the CAM, the at least one valid tag corresponding to the valid cache code block of the plurality of cache code blocks, and update data in the volatile cache memory.

According to one aspect, a method includes steps of: receiving an instruction address, the instruction address comprising a first portion and a second portion, comparing, in a content addressable memory, the first portion of the received instruction address with a valid tag and an index, the valid tag and index stored in one entry of a content addressable memory, generating a volatile cache code block address based on the comparing the first portion of the received instruction address with the valid tag and the index, concatenating, based on a result of the comparing, the volatile cache code block address and the second portion of the received instruction address, the concatenating to generate a cache address, storing a contiguous block of instructions in a cache memory, the contiguous block of instructions to be executed by a processor, accessing at least one entry from the contiguous block of instructions in the cache memory based on the cache address, writing an updated index and an updated valid tag to the content addressable memory; and writing at least one data word to the cache memory.

### BRIEF DESCRIPTION OF THE DRAWINGS

FIG. 1 illustrates one of various examples of a memory device.

FIG. 2 illustrates a method of receiving an instruction in a memory device.

FIG. 3 illustrates a method of writing to a content-addressable memory (CAM).

### DETAILED DESCRIPTION

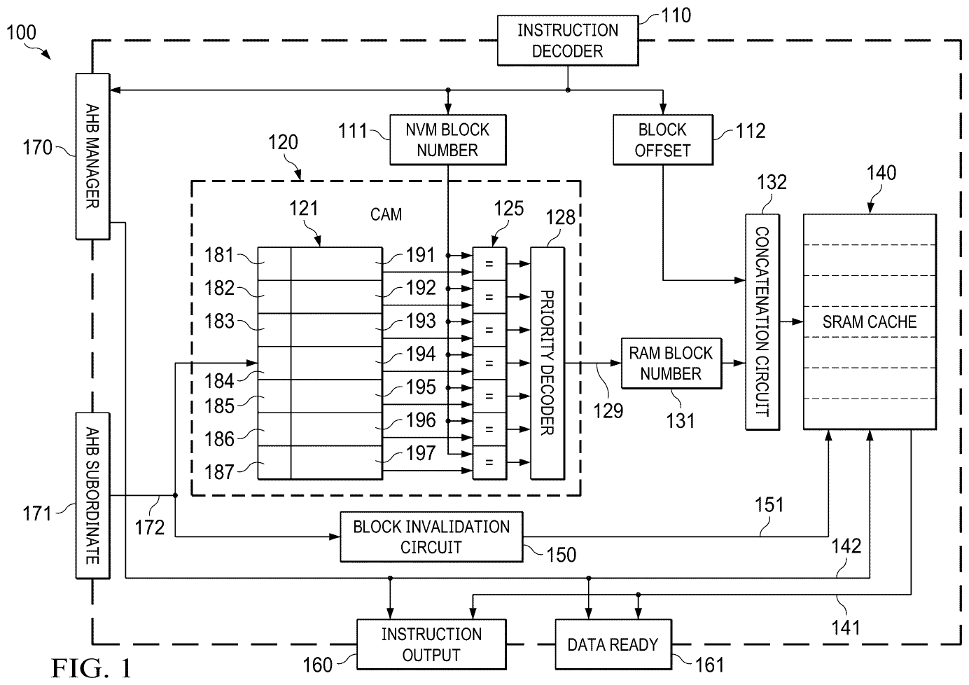

FIG. 1 illustrates one of various examples of a memory device 100. Memory device 100 may be part of a larger system including a central processing unit (CPU) and an instruction fetch unit. The larger system may include other components not specifically mentioned. The instruction fetch unit may generate an instruction address, and the instruction address may be sent to memory device 100. In operation, if the instruction corresponding to the instruction address is already stored in memory device 100, the instruction may be fetched from volatile cache memory 140 within memory device 100, saving execution time. If the instruction address is not stored in the memory device 100, the instruction may be fetched from a non-volatile memory coupled to memory device 100 and then the instruction may be stored into memory device 100 for use at a future time.

The non-volatile memory coupled to memory device 100 may include a plurality of non-volatile memory code blocks, the non-volatile memory code blocks containing a plurality of instructions to be executed by a processor.

Memory device 100 may receive an instruction address at instruction decoder 110. An instruction address may be received from an instruction fetch unit or from another circuit or address generation algorithm not specifically mentioned. The instruction address may contain an address specifying an instruction to be executed by a processor. The instruction address may be divided at instruction decoder 110 into a first portion termed a Non-Volatile Memory (NVM) block number 111 and a second portion termed a block offset 112. NVM block number 111 may uniquely identify a block of memory in volatile cache memory 140.

NVM block number 111 may be input to content-addressable memory (CAM) 120. NVM block number 111 may be used as a content input to CAM 120. CAM 120 may include multiple data words stored in storage array 121, each data word including a valid tag and an index, the index also termed a stored NVM block address. The stored NVM block address may uniquely identify a block of memory within volatile cache memory 140. Volatile cache memory 140 may include a plurality of cache code blocks, respective cache code blocks to receive one or more code blocks from the non-volatile memory coupled to memory device 100. Cache code blocks stored in volatile cache memory 140 may, for respective addresses, include cache data and a valid tag. In one of various examples, at respective addresses within volatile cache memory 140, a valid tag may be stored at a most-significant bit position, and cache data may be stored at the least-significant bit positions.

CAM 120 may indicate code blocks stored in volatile cache memory 140. CAM 120 may operate to match the NVM block number 111 from the instruction address with the index of a data word stored in storage array 121. If the NVM block number 111 numerically matches the index of a data word stored in storage array 121, this indicates the code block corresponding to NVM block number 111 is stored in volatile cache memory 140 and does not need to be fetched from a non-volatile memory coupled to memory device 100.

As one of various examples, storage array 121 within CAM 120 may include multiple data words, the data words corresponding to respective cache code blocks of a plurality of cache code blocks stored in volatile cache memory 140. As one of various examples, a first data word may include first valid tag 181 and first stored NVM block address 191, a second data word may include second valid tag 182 and second stored NVM block address 192, a third data word may include third valid tag 183 and third stored NVM block address 193, a fourth data word may include fourth valid tag 184 and fourth stored NVM block address 194, a fifth data word may include fifth valid tag 185 and fifth stored NVM block address 195, a sixth data word may include sixth valid tag 186 and sixth stored NVM block address 196, and a seventh data word may include seventh valid tag 187 and seventh stored NVM block address 197. The example illustrated in FIG. 1 includes seven data words stored in storage array 121 of CAM 120, but this is not intended to be limiting. Storage array 121 within CAM 120 may store other data or information not explicitly mentioned.

Comparison circuit 125 may compare the received NVM block number 111 with the stored NVM block addresses 191, 192, 193, 194, 195, 196, 197. The stored NVM block addresses may be read as part of a memory access to CAM 120. If NVM block number 111 matches with one of stored NVM block addresses 191, 192, 193, 194, 195, 196, 197, and the respective valid tag is set to the valid state, this event is termed a CAM hit and CAM 120 may output the data in the matching stored NVM block address. A valid tag set to the valid state may also be termed an asserted valid tag. The data in the matching stored NVM block address may be termed a volatile cache code block address. If the NVM block number 111 does not match one of the stored NVM block addresses 191, 192, 193, 194, 195, 196, 197, or the respective valid tag is set to the invalid state, this event is termed a CAM miss and thus the instruction received at instruction decoder 110 must be fetched from the non-volatile memory coupled to memory device 100.

As one of various examples, the valid state may be a logic high value, and the invalid state may be a logic low value.

Priority decoder 128 may receive input from comparison circuit 125. The input to priority decoder 128 may be a one-hot signal or may be zero, because there may be only one match between NVM block number 111 and the stored NVM block addresses. The one-hot signal to priority decoder 128 may be all zeroes, or may have a single bit set to logic high, the logic high state indicating a match between NVM block number 111 and one of the stored NVM block addresses. Based on the value of the input from comparison circuit 125, priority decoder 128 may decode the input from a one-hot signal to an encoded binary index. As one of various examples, an input from comparison circuit 125 may be a 4-bit signal, and may be a one-hot signal. The input from comparison circuit 125 may be decoded into a 2-bit index based on the following mapping: 0001->00, 0010->01, 0100->10, 1000->11. This example includes a 4-bit input from comparison circuit 125, but this is not intended to be limiting. Other examples may include inputs from comparison circuit 125 of different data widths.

In one of various examples of a CAM hit, CAM 120 may output the volatile cache code block address as RAM block number 131. RAM block number 131 may be concatenated with block offset 112 at concatenation circuit 132. The output of concatenation circuit 132 may be a cache address. The cache address may be input to volatile cache memory 140, and the data may be accessed in volatile cache memory 140. If the valid tag in volatile cache memory 140 is set to the valid state, the access is termed a cache hit and the data accessed from volatile cache memory 140 may be output as RAM output 141. RAM output 141 may be output from memory device 100 as instruction output 160. A valid tag in volatile cache memory 140 set to the valid state may be indicative of valid data stored in the volatile cache memory.

Data Ready circuit 161 may inform an external circuit when an instruction is ready to be processed. The external circuit may be a CPU, a microprocessor, a microcontroller, or another circuit capable to process an instruction. In cases of a cache hit, an HREADY signal or another signal may be set by volatile cache memory 140 to indicate data is ready and may be input to Data Ready circuit 161. In cases of a cache miss, the data ready indicator may be delayed until an instruction is fetched from a non-volatile memory coupled to memory device 100. Data Ready circuit 161 may inform an external circuit after an instruction is fetched from a non-volatile memory coupled to memory device 100.

Block invalidation circuit 150 may control operation of memory device 100 in cases where storage array 121 may be updated. Block invalidation circuit 150 may invalidate all addresses in volatile cache memory 140 which correspond to a CAM hit. Block invalidation circuit 150 all entries in volatile cache memory 140 which map to the entry in the CAM that is updated.

Block invalidation circuit 150 may update valid tags in at least one code block in storage array 121 of CAM 120 and may update an index value in at least one code block in volatile cache memory 140.

AHB manager 170 may request instructions from a non-volatile memory coupled to memory device 100. AHB manager 170 may request instructions during a cache miss event. AHB manager 170 may initiate a read transaction on a memory bus. In the example illustrated in FIG. 1, the memory bus may be a AHB memory bus, but this is not intended to be limiting.

AHB subordinate 171 may enable programming of new entries into CAM 120. A device, including but not limited to a CPU, may communicate with the memory bus and may initiate a write transaction to CAM 120.

In operation, memory device 100 may be set to a reset state. During the reset state, block invalidation circuit 150 may invalidate all entries in volatile cache memory 140. During the reset state, no writes to CAM 120 may be allowed.

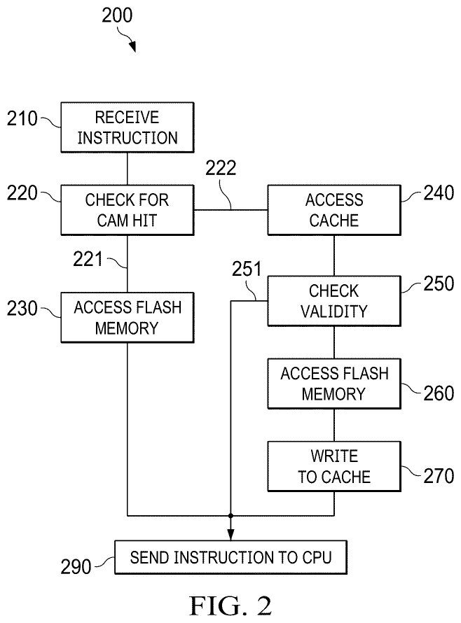

FIG. 2 illustrates a method 200 of receiving an instruction in a memory device.

At operation 210, an instruction address may be received in a memory device. The instruction address may be one of various examples of an instruction address received at instruction decoder 110 as described and illustrated in reference to FIG. 1.

At operation 220, the memory device may check for a CAM hit as described and illustrated in reference to FIG. 1. As one of various examples, the address of the received instruction may be split into a first portion, an NVM block number, and a second portion, a block offset. The NVM block number may be input to a CAM, and if the NVM block number matches an NVM block stored in the CAM, the device may record a CAM hit and operation may progress to operation 240. If the NVM block number does not match an NVM block stored in the CAM, the device may record a CAM miss and operation may progress to operation 230.

At operation 230, in the event of a CAM miss at operation 220, an instruction may be accessed from a non-volatile memory and may be sent to the CPU at operation 290.

At operation 240, in the event of a CAM hit at operation 220, a volatile cache memory in the memory device may be accessed. The volatile cache memory may be accessed using a volatile cache code block address, the volatile cache code block address formed by concatenating the NVM block read from the CAM and the block offset. A cache data word may be read from the volatile cache memory using the volatile cache code block address, the cache data word including an instruction and validity information.

At operation 250, the validity information in the cache data word may be checked, and if the validity information is set to the valid state, indicating the cache data word is valid, the event may be termed a cache hit and the cache data word may be sent to the CPU as an instruction at operation 290. If the validity information is set to the invalid state, indicating the cache data word is not valid, the event may be termed a cache miss and operation may progress to operation 260, and the instruction may be fetched from a non-volatile memory external to the cache memory. At operation 270, the instruction may be written to the cache memory as a new cache data word, and the validity information may be set to the valid state. After the instruction is written to the cache memory, at operation 290, the instruction may be sent to the CPU.

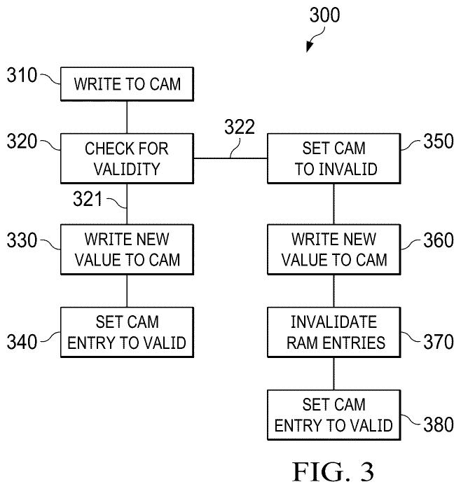

FIG. 3 illustrates a method 300 of writing to a content-addressable memory (CAM).

At operation 310, a write operation to the CAM may be received by the memory device. The write operation may include an instruction address. The write operation may be received at AHB Subordinate 171 as described and illustrated in reference to FIG. 1.

At operation 320, a validity check may be performed. The CAM entry with a stored NVM block address matching the instruction address in the write operation may be checked for validity. If the validity bit of the CAM entry with a stored NVM block address matching the instruction address of the write operation is set to the valid state, operation may progress to operation 350. If the validity bit of the CAM entry with a stored NVM block address matching the instruction address of the write operation is set to the invalid state, operation may progress to operation 330.

At operation 330, the instruction address of the write operation may be written to the CAM at one of the stored NVM block addresses. At operation 340, the valid tag of the stored NVM block address may be set to the valid state.

At operation 350, the valid tag at the stored NVM block address matching the instruction address of the write operation may be set to the invalid state. At operation 360, the instruction address of the write operation may be written to the CAM at the stored NVM block address matching the instruction address of the write operation.

At operation 370, the entries in the volatile cache memory matching the stored NVM block address may be invalidated. At operation 380, the valid tag at the stored NVM block address matching the instruction address of the write operation may be set to the valid state.

1. An apparatus comprising:
a non-volatile memory comprising a plurality of non-volatile memory code blocks, respective non-volatile memory code blocks containing a plurality of instructions to be executed by a processor;
a volatile cache memory comprising a plurality of cache code blocks, respective cache code blocks to receive one of the plurality of non-volatile memory code blocks, the volatile cache memory to provide an instruction based at least on a cache address;
an instruction decoder to receive an instruction address, the instruction address comprising a first portion and a second portion;
a content addressable memory (CAM) comprising:
a storage array comprising a plurality of data words, respective data words comprising a valid tag and an index, respective data words corresponding to respective cache code blocks of the plurality of cache code blocks;
a comparison circuit, the comparison circuit to compare the first portion of the received instruction address and the respective indices of the plurality of data words in the storage array, and the comparison circuit to generate a volatile cache code block address based on the valid tag and a result of the comparison;
a concatenation circuit to concatenate the volatile cache code block address and the second portion of the received instruction address to generate the cache address; and
a block invalidation circuit coupled to the volatile cache memory, the block invalidation circuit to, based on receiving a write transaction to a valid cache code block of the plurality of cache code blocks, update at least one valid tag in the storage array of the CAM, the at least one valid tag corresponding to the valid cache code block of the plurality of cache code blocks, and to update at least one cache code block in the volatile cache memory.

2. The apparatus as claimed in claim 1, the comparison circuit to generate the volatile cache code block address based on the first portion of the received instruction address numerically matching a respective index within the storage array and based on a valid tag in the valid state, the valid tag corresponding to the numerically matching respective index.

3. The apparatus as claimed in claim 1, the comparison circuit to generate the volatile cache code block address based on a memory access in the CAM.

4. The apparatus as claimed in claim 1, the block invalidation circuit to set the at least one valid tag in the storage array of the CAM to a valid state, and to write at least one index to the storage array.

5. The apparatus as claimed in claim 1, the block invalidation circuit to set the at least one valid tag to an invalid state, and to write at least one data word to the volatile cache memory.

6. A system comprising:
a processor;
a non-volatile memory comprising a plurality of non-volatile memory code blocks, respective non-volatile memory code blocks containing a plurality of instructions to be executed by the processor;
a software programmable cache memory apparatus coupled to the processor, the software programmable cache memory apparatus comprising:
a volatile cache memory comprising a plurality of cache code blocks, respective cache code blocks to receive one of the plurality of non-volatile memory code blocks, the volatile cache memory to provide an instruction based at least on a cache address;
a content addressable memory (CAM) comprising:
an instruction decoder to receive an instruction address, the instruction address comprising a first portion and a second portion;
a storage array comprising a plurality of data words, respective data words comprising a valid tag and an index, respective data words corresponding to respective cache code blocks of the plurality of cache code blocks;
a comparison circuit, the comparison circuit to compare the first portion of the received instruction address and the respective indices of the plurality of data words, and the comparison circuit to generate a volatile cache code block address based on the valid tag and a result of the comparison;
a concatenation circuit to concatenate the volatile cache code block address of the comparison circuit and the second portion of the received instruction address to generate the cache address; and
a block invalidation circuit coupled to the volatile cache memory, the block invalidation circuit to, based on receiving a write transaction to a valid cache code block of the plurality of cache code blocks, update at least one valid tag in the storage array of the CAM, the at least one valid tag corresponding to the valid cache code block of the plurality of cache code blocks, and update data in the volatile cache memory.

7. The system as claimed in claim 6, the comparison circuit to generate the volatile cache code block address based on the first portion of the received instruction address numerically matching a respective index within the storage array and based on a valid tag of the matching respective index set to the valid state.

8. The system as claimed in claim 6, the block invalidation circuit to write at least one valid tag to the valid state in the storage array of the CAM and to write a first index value to one of the plurality of data words of the storage array.

9. The system as claimed in claim 8, the block invalidation circuit to write a first index value to one of the plurality of data words of the storage array based on the first index value not in the plurality of data words of the storage array.

10. The system as claimed in claim 6, the block invalidation circuit to write at least one valid tag to the invalid state in the storage array of the CAM and to write at least one data word to the volatile cache memory.

11. The system as claimed in claim 10, the block invalidation circuit to write at least one data word to the volatile cache memory based on a first index value matching an index in the storage array of the CAM.

12. The system as claimed in claim 6, the block invalidation circuit to invalidate at least one entry in the volatile cache memory during a reset state.

13. A method comprising:
receiving an instruction address, the instruction address comprising a first portion and a second portion;
comparing, in a content addressable memory, the first portion of the received instruction address with a valid tag and an index, the valid tag and index stored in one entry of a content addressable memory;
generating a volatile cache code block address based on the comparing the first portion of the received instruction address with the valid tag and the index;
concatenating, based on a result of the comparing, the volatile cache code block address and the second portion of the received instruction address, the concatenating to generate a cache address;
storing a contiguous block of instructions in a cache memory, the contiguous block of instructions to be executed by a processor;
accessing at least one entry from the contiguous block of instructions in the cache memory based on the cache address;
writing an updated index and an updated valid tag to the content addressable memory; and
writing at least one data word to the cache memory.

14. The method as claimed in claim 13, the generating the volatile cache code block address based on the comparing the first portion of the received instruction address with the valid tag and the index comprises generating the volatile code block address based on the first portion of the received instruction address numerically matching a respective index in the content addressable memory and the valid tag corresponding to the respective index set to the valid state.

15. The method as claimed in claim 13, comprising generating the volatile cache code block address based on a memory access within the content addressable memory.

16. The method as claimed in claim 13, the writing the updated index and the updated valid tag to the content addressable memory and writing at least one data word to the cache memory comprising writing the updated index and the updated valid tag representing a valid index based on the updated index not matching an index in the content addressable memory.

17. The method as claimed in claim 13, the writing the updated index and the updated valid tag to the content addressable memory and writing at least one data word to the cache memory comprising writing the updated index and the updated valid tag representing an invalid index based on the updated index matching an index in the content addressable memory.
